(19) United States
(12) Patent Application Publication
(10) Pub. No.: US 2010/0138283 A1
(43) Pub. Date: Jun. 3, 2010

(54) AUDIENCE RESEARCH DATA COLLECTION METHOD AND SYSTEM FOR IPTV SERVICE

(75) Inventors: Ji Eun Keum, Suwon-si (KR); Sung Oh Hwang, Yongin-si (KR); Bo Sun Jung, Seongnam-si (KR)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/628,658

(22) Filed: Dec. 1, 2009

(30) Foreign Application Priority Data
Dec. 1, 2008 (KR) 10-2008-0120697

(51) Int. Cl. G06Q 10/00

(52) U.S. Cl. 705/10

(57) ABSTRACT

An audience research data collecting method and system for collecting audience research data from devices connected to an IP service. An audience research data reporting method of a device includes receiving an audience research data collection management object for collecting audience research data from a device management server, configuring a reporting condition of the audience research data collection management object based on parameters received from the device management server and collecting and reporting the audience research data to the device management server according to the reporting condition.

### PRIORITY

This application claims priority to an application filed in the Korean Intellectual Property Office on Dec. 1, 2008 and assigned Serial No. 10-2008-0120697, the content of which is incorporated herein by reference.

### BACKGROUND OF THE INVENTION

1. Field of the Invention

The present invention relates generally to an Internet Protocol TeleVision (IPTV) service system and, in particular, to a method and system for collecting audience research data from devices connected to an IP service through wireless and/or wired links using a device management protocol.

2. Description of the Related Art

The IP-based convergence of communication and broadcast services is emerging as a new business model with promising marketability. As one of the best examples of the communication and broadcast convergences, Internet protocol TeleVision (IPTV) technology provides opportunities for different business models and services, as well as a combination of conventional TV, voice, and information technologies. Particularly, the IPTV technology enables fixed terminals (such as set-top boxes, Personal Computers (PCs), and Television sets) and mobile devices (such as mobile phones, Personal Digital Assistants (PDAs), and laptop computers) to receive flexible communication and broadcast services in any environment using wired, wireless, and broadcast networks.

Various technologies for remote management of the devices connected to a communication network have been developed or are currently in the middle of standardization. The Device Management (DM) of Open Mobile Alliance (OMA) is a representative mobile device management protocol.

In an OMA DM system, a DM server sends a DM message to a mobile device provided with a DM client to get, write, or execute a Management Object (MO) as a device parameter or execution file, thereby monitoring and reporting device capability.

Another remote management technology, TR069 of DSL Forum, defines a protocol for remote management of end-user devices connected to a wired communication network.

FIG. 1 is a diagram illustrating a procedure for collecting audience research data in a conventional IPTV system.

Referring to FIG. 1, in the conventional IPTV system, an operator 150 in the service provider domain 130 makes a call to a subscriber 100 to establish a telephone line (160→120) and collects the audience research data about the IP TV service (140→110). However, such manual information collection process is costly and inconvenient from both the service provider's and subscriber's viewpoints.

### SUMMARY OF THE INVENTION

The present invention is designed to address at least the above-mentioned problems and/or disadvantages and to provide at least the advantages described below. Accordingly, an aspect of the present invention provides a method and system for an IPTV service for efficiently collecting audience research data.

Another aspect of the present invention, provides a method and system for an IPTV service are provided that collect audience research data based on an audience research data report condition set by the IPTV service provider.

In accordance with an aspect of the present invention, an audience research data reporting method includes receiving an audience research data collection management object for collecting audience research data from a device management server; configuring a reporting condition of the audience research data collection management object based on parameters received from the device management server; and collecting and reporting audience research data to the device management server according to the reporting condition.

In accordance with another aspect of the present invention, an audience research data collecting method of a device management server includes sending an audience research data collection management object to a device; sending the device a reporting condition configuration command for configuring a reporting condition of the audience research data collection management object; and receiving audience research data collected by the device according to the reporting condition.

In accordance with another aspect of the present invention, an audience research data reporting system includes a device for receiving an audience research data collection management object for collecting audience research data from a device management server; configuring a reporting condition of the audience research data collection management object based on parameters received from the device management server; and collecting and reporting audience research data to the device management server according to the reporting condition.

In accordance with another aspect of the present invention, an audience research data collecting system includes a device management server for sending an audience research data collection management object to a device; sending the device a reporting condition configuration command for configuring a reporting condition of the audience research data collection management object; and receiving audience research data collected by the device according to the reporting condition.

### BRIEF DESCRIPTION OF THE DRAWINGS

The above and other aspects, features, and advantages of the present invention will be more apparent from the following detailed description in conjunction with the accompanying drawings, in which:

FIG. 1 is a diagram illustrating a procedure for collecting audience research data in a conventional IPTV system;

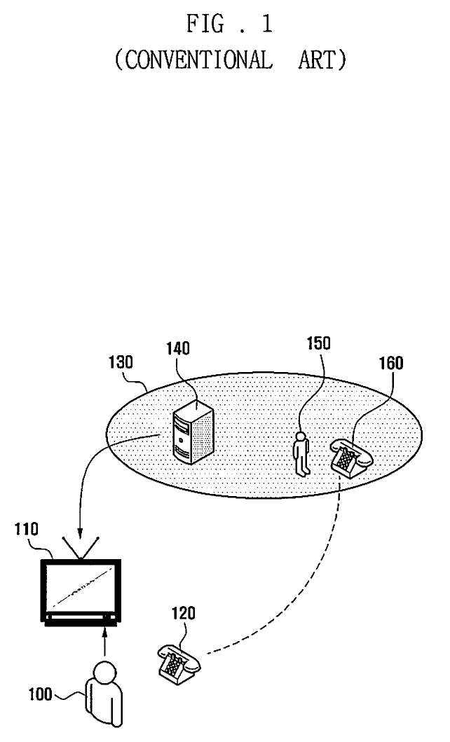

FIG. 2 is a diagram illustrating an IPTV service provision architecture according to an embodiment of the present invention;

FIG. 3 is a schematic diagram illustrating an audience research data collection system for an IPTV service according to an embodiment of the present invention;

FIG. 4 is a diagram illustrating a structure of an audience research management object for use in an audience research data collection method, according to an embodiment of the present invention;

FIG. 5 is a sequence diagram illustrating operations of entities of an audience research data collection system for an IPTV service according to an embodiment of the present invention;

FIG. 6 is a sequence diagram illustrating operations of entities of an audience research data collection system for an IPTV service according to an embodiment of the present invention;

FIG. 7 is a flowchart illustrating an audience research data collection method for an IPTV service provision system according to an embodiment of the present invention;

FIG. 8 is a sequence diagram illustrating operations of entities of an IPTV service provision system according to an embodiment of the present invention;

FIG. 9 is a diagram illustrating an audience research data collection system for providing a device connected to a home network with an IPTV service according to an embodiment of the present invention;

FIG. 10 is a sequence diagram illustrating operations of entities of the audience research data collection system illustrated in FIG. 9 for an IPTV service according to an embodiment of the present invention; and

FIG. 11 is a sequence diagram illustrating operations of entities of the audience research data collection system illustrated in FIG. 9 for and IPTV service according to an embodiment of the present invention.

### DETAILED DESCRIPTION OF EMBODIMENTS OF THE INVENTION

Various embodiments of the present invention are described with reference to the accompanying drawings in detail. The same reference numbers are used throughout the drawings to refer to the same or like parts. The described features and advantages of the present invention may be combined in any suitable manner in one or more embodiments and one skilled in the art will recognize that the invention may be practiced without one or more of the specific features or advantages of a particular embodiment. Further, detailed descriptions of well-known functions and structures incorporated herein may be omitted to avoid obscuring the subject matter of the present invention.

In the following description, representative embodiments of the present invention are described to aid in the understanding of the invention. For ease of description, the terms specified by the Universal Plug and Play (UPnP) Forum and the Open IPTV Forum (OIF) are interchangeably used. However, the present invention is not only limited to the UPnP and IPTV systems, but can be applied to other systems implemented with similar technical backgrounds.

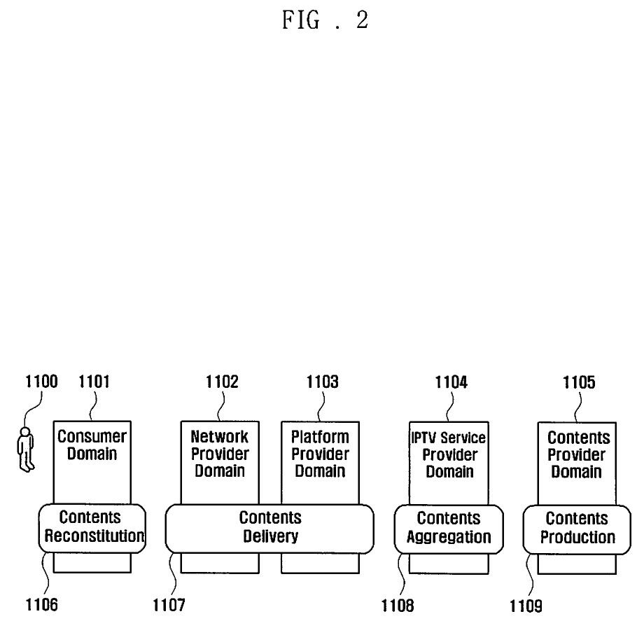

FIG. 2 is a diagram illustrating an IPTV service provision architecture according to an embodiment of the present invention.

Referring to FIG. 2, the IPTV value chain includes various domains. In order to provide a consumer 1100 with the IPTV service, there are five domains involved: a Consumer Domain 1101, a Network Provider Domain 1102, a Platform Provider Domain 1103, an IPTV Service Provider Domain 1104, and a Content Provider Domain 1105.

The consumer domain 1101 is where the IPTV services are consumed. The consumer domain 1101 may include a single device or a network of devices (e.g., a home network). Here, the devices may include mobile devices such as cellular phones and Personal Digital Assistants (PDAs), as well as fixed devices, such as set-top boxes.

The network provider domain 1102 connects the consumer to platform and service providers and is responsible for delivery of various types of services and content. The delivery system of a network provider domain 1102 generally includes access networks and core or backbone networks, using a variety of network technologies such as wired and wireless access technologies and broadcast technologies.

The platform provider domain 1103 provides common services, such as user authentication and billing, to IP service providers.

The IPTV service provider domain 1104 provides IPTV services to the customer domain 1101. The IPTV provider acquires/licenses content from the content providers and packages the content into a service.

The content provider domain 1105 owns or is licensed to sell content or content assets.

In this type of five domain architecture, a variety of IPTV services including scheduled content services and content on-demand services may be supplied to the consumer equipment. Both of those services follow the content value chain including the following four roles: a Content Production Unit 1109, a Content Aggregation unit 1108, a Content Delivery Unit 1107, and a Content Reconstitution Unit 1106.

The content production unit 1109 is placed in the content provider domain 1105 and is responsible for producing and editing the actual content.

The content aggregation unit 1108 is placed in the IPTV service provider domain 1104 and is responsible for bundling content into catalog offers and bouquets.

The content delivery unit 1107 is normally placed across the platform provider domain 1103 and the network provider domain 1102 and is responsible transporting the aggregated contents to the consumer domain 1101.

The content reconstitution unit 1106 is normally placed in the consumer domain 1101 and is responsible for converting the content into a format suitable for rendering on the end-user device.

The IP services can be generally distinguished in two main categories depending on the Quality of Service (QoS): (1) Managed Model and (2) Unmanaged Model (Open Internet). In the managed model, a service provider manages the platform provider domain 1103, the network provider domain 1102, and the IPTV service provider domain 1104. In the unmanaged model, the service provider is separated from the network provider, whereby the service provider belongs to the IPTV service provider domain 1104, and the network provider domain 1102 and the platform provider domain 1103 are managed by different stakeholder.

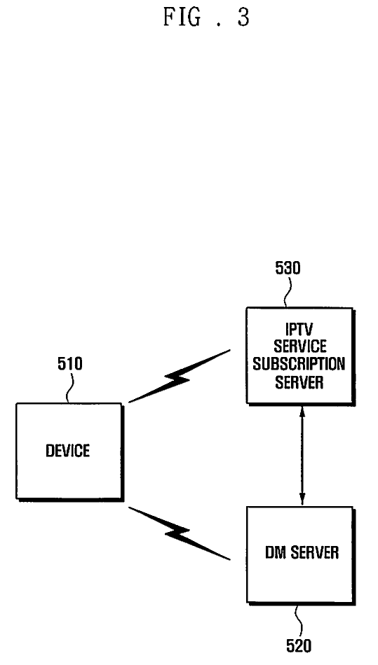

FIG. 3 is a schematic diagram illustrating an audience research data collection system for an IPTV service according to an embodiment of the present invention.

Referring to FIG. 3, the audience research data collection system according to an embodiment of the present invention includes a customer device 510, a Device Management (DM) server 520, and an IPTV service subscription server 530.

The customer device 510 may connect to a core network via a radio access network including the DM server 520 as a network entity. The IPTV service subscription server 530 also may be implemented as a network entity of the core network. The DM server 520 and the IPTV service subscription server 530 are servers of the IPTV service provider.

The customer device 510 receives the content from the IPTV service provider. The customer device 510 is implemented with an OMA DM client and UPnP Execution Platform to support the OMA DM protocol. Particularly, the customer device 510 sends a view condition report and audience research data to the DM server 520. The customer device 510 also creates, saves, and executes an audience research management object and transmits the audience research data to the DM server 520.

The user device 510 can access the DM server of the core network through a radio access network.

The DM server 520 sends a DM message to the remote customer device 510 equipped with a DM client using the DM protocol to get, write, and execute a Management Object (MO), such as an internal parameter or an execution file, thereby monitoring and reporting the device capability.

In accordance with an embodiment of the present invention, the DM server 520 sends a report condition for collecting the audience research data, and collects and reports the audience research data when the report condition is fulfilled.

The IP service subscription server 530 is a server belonging to the IPTV service provider and provides a subscription management service for the IPTV service.

In accordance with an embodiment of the present invention, a method for the IPTV service provider to collect the audience research data occurs automatically.

The audience research data collection method should be implemented such that all licensed IPTV service providers can obtain the customer's view pattern from any type of IPTV device.

There is therefore a need for a standardized audience research data measurement method.

In accordance with an embodiment of the present invention, a standardized method for the IPTV service provider to acquire the customer's view pattern from the customer device 510 is provide.

The customer device 510 can be configured to report per-content audience research data to the DM server 520.

Also, the customer device 510 can collect the audience research data per class of the contents.

In accordance with an embodiment of the present invention, an audience research management object is defined with content Identification (ID) and class ID as shown in table 1, in order for the IPTV service provider to set a report type for collecting the audience research data.

TABLE 1

| Class ID | Content ID |
|---|---|
| Class 1 | 1~5 |
| Class 2 | 6~10 |
| . . . | . . . |

As shown in table 1, the contents are stored with the mapping information by class. Assuming that class 1 is the class ID indicating an advertisement, the contents stored with Content IDs 1 to 5 mapped to the class 1 belong to the advertisement category.

Similarly, assuming that class 2 is the class ID indicating content on-demand, the contents stored with the content IDs 6 to 10 mapped to the class 2 belong to the content on-demand category.

By identifying the contents with class IDs and contents IDs, it is possible to collect the audience research data under a specific report condition.

For example, the report condition can be configured such that the audience research data is reported to the IP service provider when the customer views an advertisement at least one time. Also, it is possible to configure the report condition such that the audience research data is reported to the IP service provider at a certain time of day when the customer has subscribed to a content on-demand service. In this manner, the DM server 520 configures the report condition under which the customer device 510 reports the audience research data.

In accordance with an embodiment of the present invention, the audience research data report condition can be set differently depending on the content subscribed by the customer. The DM server 520 defines the management information of the customer device 510 equipped with the DM client in the form of a DM tree and manages the management objects using the DM technology.

In accordance with an embodiment of the present invention, an audience research management object is defined with parameters for collecting the audience research data. As described above, the audience research data report condition can be configured by means of the audience research management object.

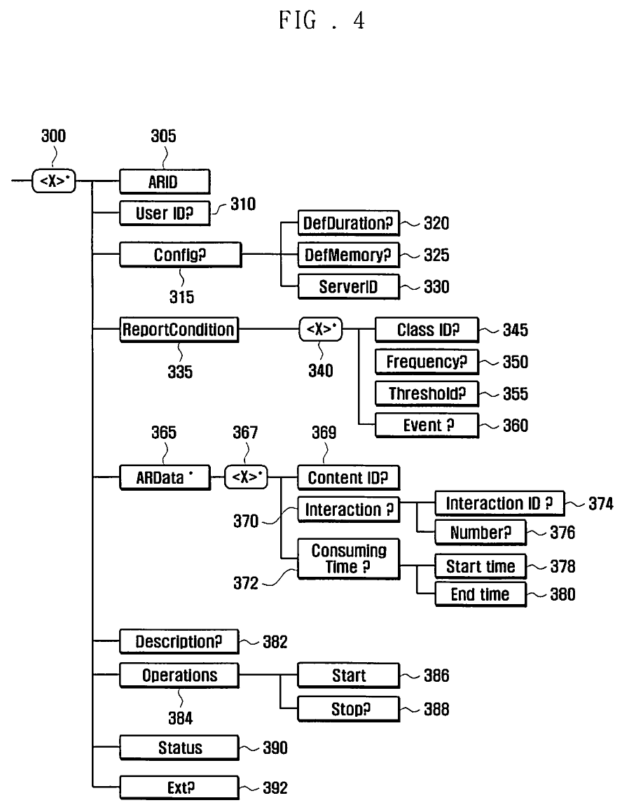

FIG. 4 is a diagram illustrating a structure of an audience research management object for use in an audience research data collection method according to an embodiment of the present invention.

Referring to FIG. 4, the audience research management object includes a plurality of parameters for collecting the audience research data. Reference numeral 300 denotes a node representing the audience research management object, and a customer device can include plural view information management objects. The audience research management object 300 includes an Audience Research ID (ARID) node 305, a UserID node 310, a Configuration (Config) node 315, a ReportCondition node 335, an Audience Research Data (ARData) node 365, a Description node 382, an Operation node 384, a status node 390, and an Extra (Ext) node 392.

More specifically, the Config node 315 includes a Defined Duration (DefDuration) node 320, a Defined Memory (DefMemory) node 325, and a ServerID node 330. The ReportCondition node 335 includes a Class ID node 345, a Frequency node 350, a Threshold node 350, and an Event node 360.

The ARData node 365 includes a ContentID node 369, an Interaction node 370, and a Consuming Time node 372. The interaction node 370 includes an Interaction ID node 374 and a Number node 376. The Consuming Time node 372 includes a Start time node 378 and an End time node 380.

The operation node 382 includes a Start node 386 and a Stop node 388.

The ARID node 305 is the identifier of the audience research management object and has an integer value. The UserID node 310 is the identifier of the customer subscribed to the IPTV service.

The Config node 315 includes the configuration information on an operation for collecting the audience research data. The DefDuration node 320 includes a value of the time duration for collecting the audience research data. If the time duration expires, the audience research data collection is stopped. The DefMemory node 325 contains a value of an amount of memory available for collecting the audience research data. If the data reaches the memory amount indicated by the DefMemory node 325, the audience research data collection is stopped automatically. The ServerID node 330 includes the address (e.g., a URI value) of the server to which the collected audience research data it transmitted.

The ReportCondition node 335 is an upper node including the condition values required for transmitting the collected audience research data to the server. Here, the reference numeral 340, i.e., <x>, indicates that when there are multiple groups of audience research data to be transmitted to the DM server 520, multiple groups of audience research data are arranged. The group includes Class ID node 345, Frequency node 350, Threshold node 355 and Event node 360. The ClassID node 345 includes the identifier of the class to which the content viewed by the customer belongs. The class indicates the type of content. If the ClassID node 345 is set to 0, the audience research data is reported according to one report type regardless of the types of the content. The Frequency node 350 includes a value indicating how often the collected audience research data is transmitted to the server. That is, the Frequency node 350 indicates the audience research data collecting frequency.

The Event node 360 includes information on the report type and condition set by the IPTV service provider. For example, the event node 360 may be configured to report when the content type is changed from content A to content B. The Event node 360 is set to an eXtensible Markup Language (XML) type value. That is, the Event node 360 specifies the event for triggering the audience research data report.

The ARData node 365 includes the collected view data. The <x> 367 indicates that a variety of collected view data can exist. The ContentID node 369 includes the identifier of the content viewed by the IPTV customer.

The Interaction node 370 includes a value related to the interaction carried out by the customer while the IPTV customer is viewing the content. The Interaction ID node 374 includes an identifier of the interaction carried by the IPTV customer. The Number node 376 includes a value indicating a number of interactions carried by the IPTV customer.

The Consuming Time node 372 includes information on a time the IPTV customer has view the contents. The Start time node 378 includes a time the IPTV customer starts viewing the contents. The End time node 380 includes a time the IPTV customer ends viewing the contents.

The Description node 382 includes description on the audience research management object.

The Operation node 384 includes sub-nodes for executing the audience research data collection. The Start node 386 executes a start command for starting the audience research data collection, and the Stop node 388 executes an end command for terminating the audience research data collection.

The Status node 390 includes a current status of the audience research management object, which indicates whether the audience research data is in the middle of collection, collected, or reported.

The Ext node 392 is a node reserved for the future development.

In accordance with an embodiment of the present invention, the audience research data is reported to the IPTV service provider when the reporting condition is fulfilled.

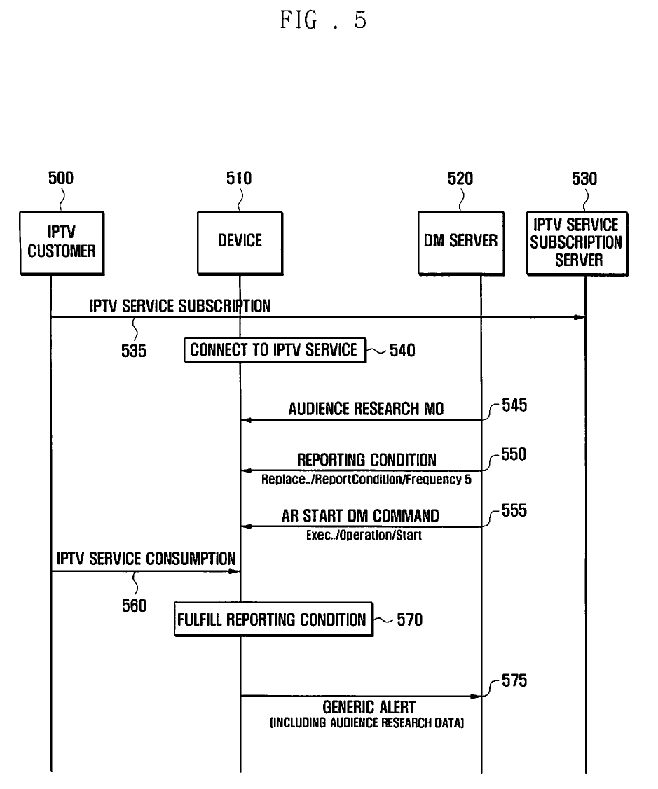

FIG. 5 is a sequence diagram illustrating operations of entities of an audience research data collection system for an IPTV service according to an embodiment of the present invention.

In order to consume the IPTV contents, a user, i.e., an IPTV customer, subscribes to an IPTV service. The IPTV customer 500 (hereinafter the terms “user”, “customer”, and “IPTV customer” are synonymously used) sends a subscription request to the IPTV service subscription server 530 for subscribing to the IPTV service in step 535. In step 540, the IPTV customer 500 accesses the IPTV service using the device 510.

Once the device 510 is connected to the IPTV service in step 540, the DM server 520 sends an Audience Research Management Object (MO) structured as shown in FIG. 4 to the device 510 with a DM command in step 545.

The DM server 520 sends a Reporting Condition with a DM command (Replace . . . /ReportCondition/Frequency=5) to the device 510 in step 550. Here, the DM server 520 can send a DM command for setting at least one sub-node of the ReportCondition node 335 of the Audience Research MO. That is, the DM command may carry a value for setting at least one of the Frequency node 350, the Threshold node 335, and the Event node 360. In FIG. 5, it is assumed that the DM command carries the value “5” for setting the Frequency node 350. The value can be set with one of various time units. In FIG. 5, it is assumed that the time unit is an “hour”.

Alternatively, steps 545 and 550 can be performed as a single process for configuring the Reporting Condition for the device 510 to collect the audience research data. That is, the DM server 520 can send the Audience Research MO containing the ReportCondition node 335 set with a specific value.

In step 555, the DM server 520 sends an Audience Research (AR) DM command (Exec . . . operation/start) for triggering AR to the device 510, and upon receipt of the AR DM command, the device 510 starts collecting audience research data.

When the device 510 has been connected to the IPTV service and has stored the Reporting Condition, the user 500 starts consuming the IPTV service in step 560. Once the user 500 starts consuming the IPTV service, the device 510 checks the previously stored Audience Research MO and determines whether the Reporting Condition is fulfilled in step 570. Because the Audience Research Mod has the Frequency node 350 set to a time value “5” in unit of hours, the device 510 monitors whether the time (i.e., 5 hours) has elapsed.

If the Reporting Condition is fulfilled, i.e., when 5 hours has elapsed since starting the IPTV service consumption, the device 500 sends a Generic Alert message with the collected Audience Research Data to the DM server 520 in step 575.

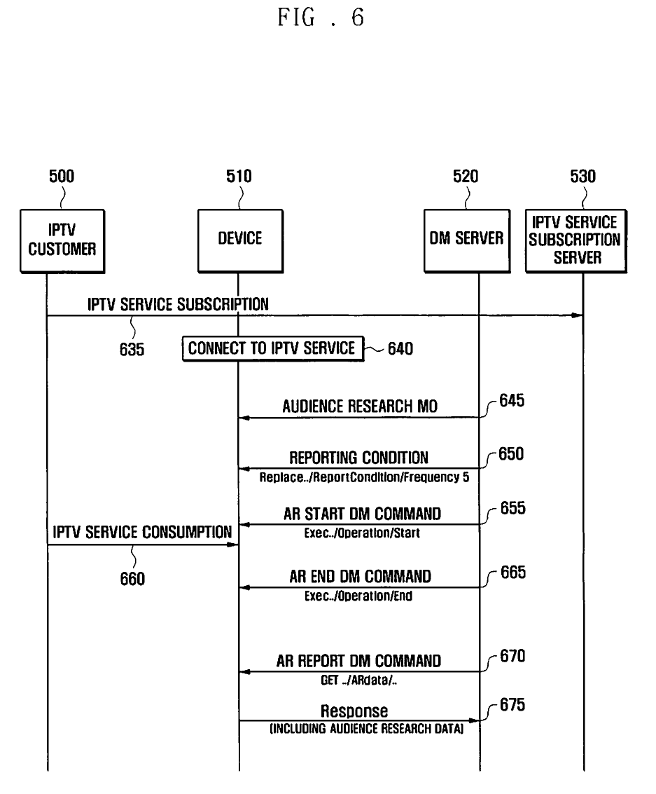

FIG. 6 is a sequence diagram illustrating operations of entities of an audience research data collection system for an IPTV service according to another embodiment of the present invention.

Referring to FIG. 6, the IPTV customer 500 sends a subscription request to the IPTV service subscription server 530 in step 635. In step 640, the IPTV customer 500 accesses the IPTV service using the device 510 (640).

Once the device 510 is connected to the IPTV service in step 640, in step 645, the DM server 520 sends an Audience Research Management Object (MO), structured as shown in FIG. 4, to the device 510, along with a DM command.

In step 650, the DM server 520 sends a Reporting Condition with a DM command (Replace . . . /ReportCondition/Frequency=5) to the device 510. Here, the DM server 520 can send a DM command for setting at least one sub-node of the ReportCondition node 335 of the Audience Research MO. That is, the DM command may carry a value for setting at least one of the Frequency node 350, the Threshold node 335, and the Event node 360.

Alternatively, steps 645 and 650 may be performed as a single process for configuring the Reporting Condition for the device 510 to collect the audience research data. That is, the DM server 520 can send the Audience Research MO containing the ReportCondition node 335 set with a specific value.

In step 655, the DM server 520 sends an Audience Research (AR) DM command ( . . . operation/start) for triggering AR to the device 510 (655). Upon receipt of the AR DM command, the device 510 starts collecting audience research data.

When the device 510 has been connected to the IPTV service and has stored the Reporting Condition, the IPTV customer 500 starts consuming the IPTV service in step 660.

While the IPTV customer 500 consumes the IPTV service, the DM server 520 sends an AR termination DM command ( . . . operation/end) for stopping the audience research data collection to the device 510 in step 665.

Upon receipt of the DM command, the device stops collecting the audience research data according to the DM command.

In step 670, the DM server 520 sends an AR report command (GET . . . /ARdata/ . . . ) for requesting the collected audience research data report to the device 510.

Upon receipt of the AR report command, the device 510 sends the collected audience research data to the DM server 520 in response to the AR report command in step 675. That is, the device 510 sends the audio research data stored in the AR data node 365 to the DM server 520.

As described above, the DM server 520 requests the device 510 to start and end collecting the audience research data and report the collected audience research data by sending the DM commands. The device 510 collects the audience research data and reports the collected audience research data to the DM server 520 according to the DM commands received from the DM server 520.

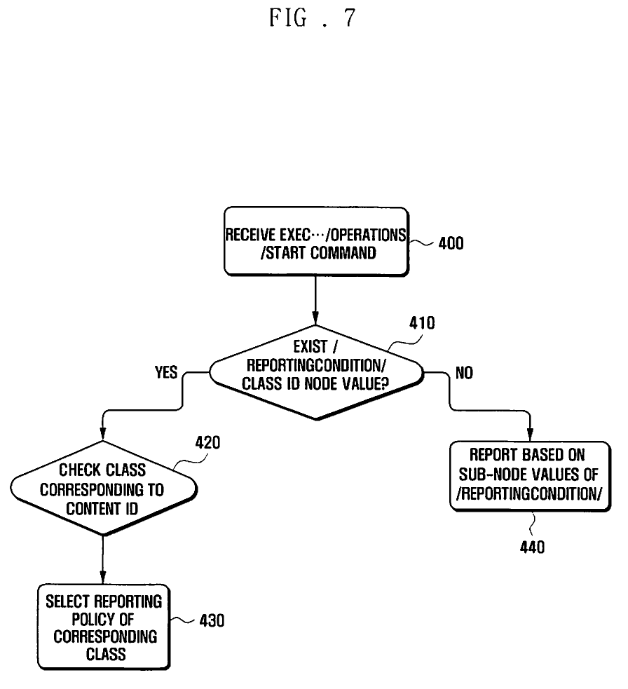

FIG. 7 is a flowchart illustrating an audience research data collection method for an IPTV service provision system according to an embodiment of the present invention.

As described above, the device 510 is equipped with the OMA DM client and UPnP Execution Platform (hereinafter called a “client”), and the client executes the DM command.

Referring to FIG. 7, the client receives an “operations/Start” command related to the audience research data collection MO in step 400. If the operations/Start command is received, the client determines whether a class ID node 345 exists under the ReportConnection node 335 in step 410.

If the class ID node 345 exists, the client checks the class of the content that the customer is consuming in step 420. In step 430, the client reports the collected audience research data to the IPTV service provider using the device 510 with reference to values of the frequency node 350, the Threshold node 355, and the Event node 360.

For example, if the content that the customer is consuming belongs to an advertisement class and the Frequency node 350 is set to “ten times a day”, the client reports the audience research data 10 times every day. If the Threshold node 355 is set to “report after three times of views”, the client reports the audience research data, after the customer views the advertisement. However, if the Event node 360 is set to “every view of the advertisement”, then the client reports the audience research data whenever the customer views the advertisement.

If the class ID node 345 does not exist at step 410, the client reports the audience research data with reference to the default values of the Frequency node 350, the Threshold node 355, and the Event node 360 in step 440.

For example, if the class ID node is set to 0, the client reports the audience research data in an identical manner regardless of the per-content reporting policy.

As described above, the audience research data collection method according to an embodiment of the present invention is capable of configuring the report condition per content. Further, the audience research data collection method is also capable of reporting the audience research data without the per-content report condition or with a default condition.

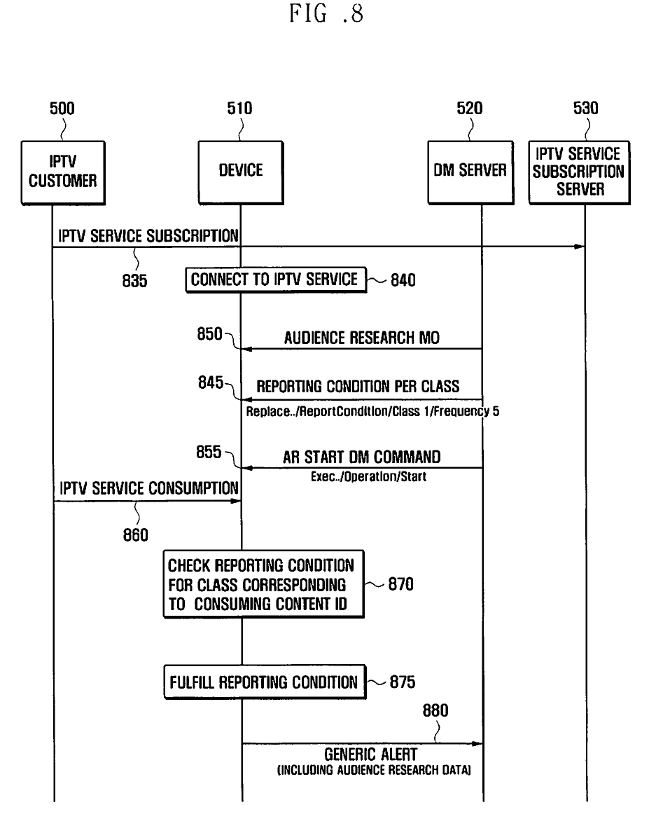

FIG. 8 is a sequence diagram illustrating operations of entities of an IPTV service provision system according to another embodiment of the present invention.

Referring to FIG. 8, the IPTV customer 500 sends a subscription request to the IPTV service subscription server 530 to subscribe to the IPTV service in step 835. In step 840, the IPTV customer 500 accesses the IPTV service by means of the device 510.

Once the device 510 is connected to the IPTV service in step 840, in step 845, the DM server 520 sends an Audience Research Management Object (MO) structured as shown in FIG. 4 to the device 510 with a DM command.

In step 850, the DM server 520 sends the per-class Reporting Conditions with a DM command (Replace . . . /ReportCondition/Frequency=5) to the device 510. Here, the DM server 520 can send a DM command for setting at least on sub-node of the ReportCondition node 335 of the Audience Research MO. That is, the DM command may carry a value for setting at least one of the Frequency node 350, the Threshold node 335, and the Event node 360. In FIG. 8, it is assumed that the DM command carries the value “5” for setting the Frequency node 350. The value can be set with one of various time units. In the embodiment of FIG. 8, as in the other figures, it is assumed that the time unit is in “hours”.

Alternatively, steps 845 and 850 can be performed as a single process for configuring the Reporting Condition for the device 510 to collect the audience research data. That is, the DM server 520 can send the Audience Research MO containing the ReportCondition node 335 set with specific value per content class.

In step 855, the DM server 520 sends an Audience Research DM command for triggering AR to the device 510. Upon receipt of the AR MD command, the device 510 starts collecting audience research data.

When the device 510 has been connected to the IPTV service and has stored the per-class Reporting Conditions, the user 500 starts consuming the IPTV service in step 860. Once the user 500 starts consuming the IPTV service, the device 510 checks the previously stored Audience Research MO and determines whether the reporting condition is fulfilled in step 870.

More specifically, the device 510 determines whether the class ID node 345 exists in step 870 and, if the class ID node 345 exists, checks whether at least one of the values of the Frequency Node 350, the Threshold node 355, and the Event node 360 is fulfilled in step 875.

Because the Class node 345 is set to Class 1 and the Frequency node 350 is set to 5, if there is content belonging to Class 1, the device 500 determines whether the content of class 1 has been consumed over 5 hours. When the content of class 1 has been consumed over 5 hours, the device 500 reports the collected audience research data to the DM server 520 in step 880.

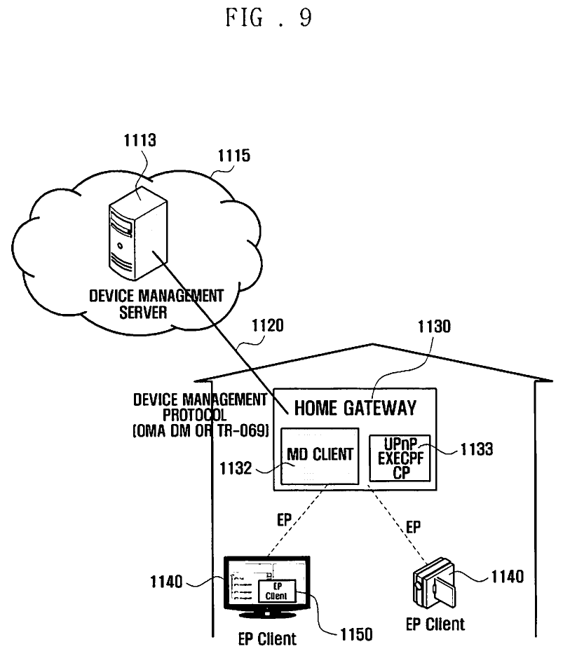

FIG. 9 is a diagram illustrating an audience research data collection system for providing a device connected to a home network with an IPTV service according to an embodiment of the present invention.

Referring to FIG. 9, a device management server 1113 is connected to a gateway 1130 using a device management protocol 1120. The home gateway 1130 includes a Device Management (DM) client 1132 and an UPnP Execution Platform control point (ExecPF CP) 1133. The UPnP ExecPF CP 1133 controls an indoor IPTV device 1140.

The device management server 1113 corresponds to the DM server 520 of FIG. 3, and the home gateway 1130 corresponds to the device 510 of FIG. 3. That is, the home gateway 1130 plays the partial or entire role of the device 510 in the above described embodiments in order to collect the audience research data from the IPTV device 1140 using the UPnP ExecPF CP as a standard home network communication technology and reports the collected audience research data to the device management server 1115.

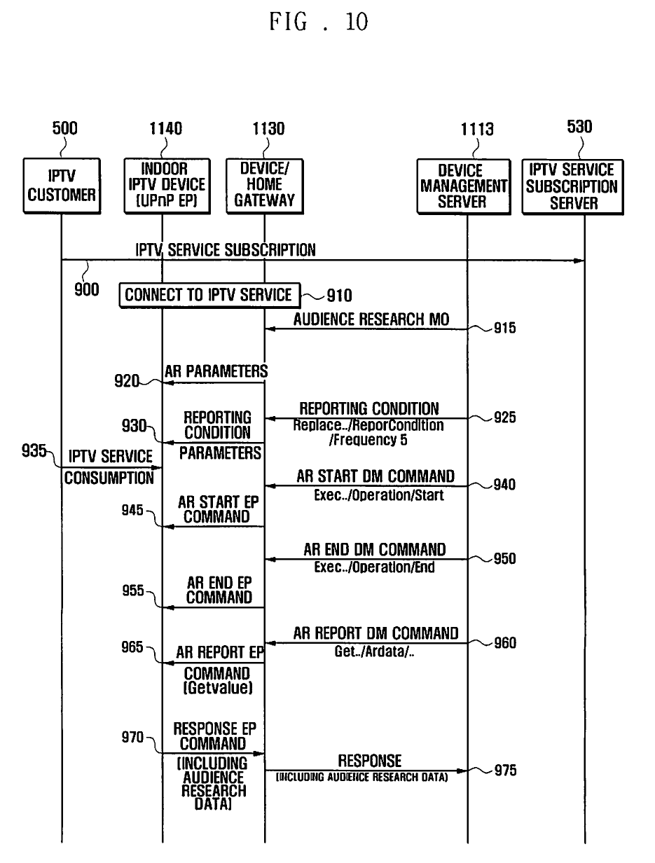

FIG. 10 is a sequence diagram illustrating operations of entities of the audience research data collection system illustrated in FIG. 9 for an IPTV service according to an embodiment of the present invention.

Referring to FIG. 10, the IPTV customer 500 sends a subscription request to the IPTV service subscription server 530 in step 900. In step 910, the IPTV customer 500 accesses the IPTV service using the indoor IPTV device 1140 via the home gateway 1130.

Once the device 1140 is connected to the IPTV service in step 910, the device management server 1113 sends an Audience Research Management Object (MO), structured as shown in FIG. 4, to the home gateway 1130 along with a DM command in step 915.

Upon receipt of the Audience Research MO, the home gateway 1130 sends audience research collection parameters converted into the UPnP format to the indoor IPTV device 1140 in step 920.

The device management server 1113 sends a DM command (Replace . . . /ReportCondition/Frequency 5) for configuring the Reporting Condition to the home gateway 1130 in step 925.

Upon receipt of the DM command with the Reporting Condition, the home gateway 1130 sends the reporting condition parameters converted into the UPnP format to the indoor IPTV device 1140 in step 930.

Alternatively, steps 915 and 925 can be performed as a signal process for transmitting the Reporting Condition to the home gateway 1130. That is, the device management server 1113 can send the home gateway 1130 the Audience Research MO with the ReportCondition node 335 having at least one sub-node value.

When the indoor IPTV device 1140 has been connected to the IPTV service and has stored the Reporting Condition, the consumer 500 starts consuming the IPTV service in step 935.

After the transmission of the Report Condition, the device management server 1113 sends a DM command ( . . . operation/start) to the home gateway 1130 for triggering the audience research data collection in step 940.

Upon receipt of the AR data correction trigger DM command, the home gateway 1130 starts collecting audience research data. That is, the home gateway 1130 sends the AR data collection trigger DM command converted into the UPnP format to the indoor IPTV device 1140 to start collection of the audience research data in step 945.

In step 950, the device management server 1113 sends an AR termination DM command to ( . . . operation/end) for stopping the audience research data collection to the home gateway 1130.

Upon receipt of the AR termination DM command, the home gateway 1130 stops collecting the audience research data according to the DM command. That is, the home gateway 1130 sends the AR termination DM command converted into the UPnP format to the indoor IPTV device 500 in step 955.

After transmitting the AR termination DM command, the device management server 1113 sends an AR data request DM command (GET . . . /ARData/ . . . ) to the home gateway 1130 in step 960.

Upon receipt of the AR data request DM command, the home gateway 1130 sends the AR data request DM command converted into the UPnP format to the indoor IPTV device 1140 in step 965.

Upon receipt of the AR data request DM command, the indoor IPTV device 1140 sends the collected audience research data to the home gateway 1113 in step 970. The home gateway 1113 sends the audience research data stored in the ARData node 635 to the device management server 1113 in step 975.

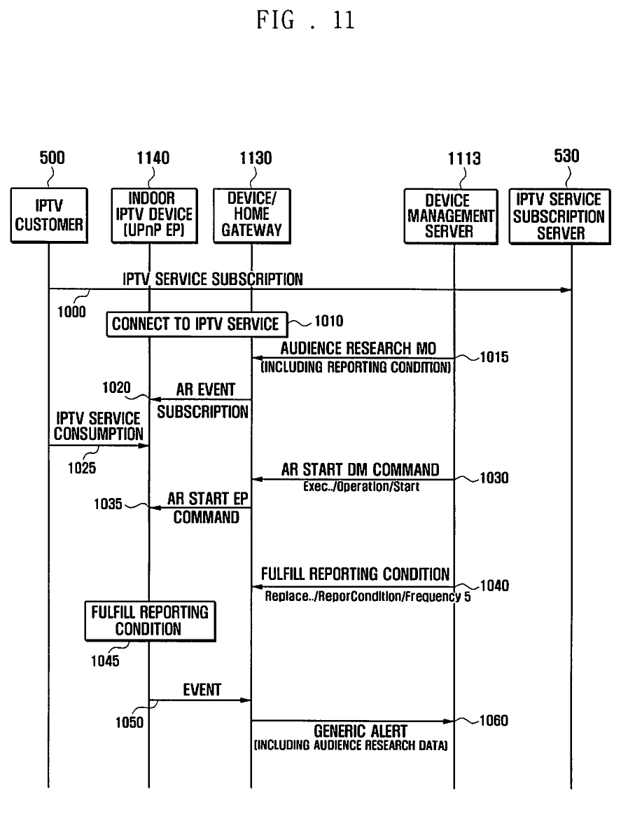

FIG. 11 is a sequence diagram illustrating operations of entities of the audience research data collection system illustrated in FIG. 9 for an IPTV service according to another embodiment of the present invention. More specifically, in FIG. 11, the indoor IPTV device 1140 is configured to collect and report the audience research data automatically.

Referring to FIG. 11, the IPTV customer 500 sends a subscription request to the IPTV service subscription server 530 in step 1000. In step 1010, the IPTV customer 500 accesses the IPTV service by means of the indoor IPTV device 1140 via the home gateway 1130.

Once the device 1140 is connected to the IPTV service, in step 1015, the device management server 1113 sends an Audience Research Management Object (MO) structured as shown in FIG. 4 to the home gateway 1130 along with a DM command. At this time, the Audience Research MO includes the Reporting Condition.

Upon receipt of the Audience Research MO with the Reporting Condition, the home gateway 1130 sends the Reporting Condition information to the indoor IPTV device 1140 and subscribes to an UPnP event service in step 1020.

When the indoor IPTV device 1140 has been connected to the IPTV service and has received the Reporting Condition, the consumer 500 starts consuming the IPTV service in step 1025.

After the transmission of the Audience Research MO, the device management server 1113 sends an AR data collection trigger DM command (Exec . . . operation/start) to the home gateway 1130 in step 1030.

Upon receipt of the AR data collection trigger DM command, the home gateway 1130 sends the AR data collection trigger DM command converted into the UPnP format to the indoor IPTV device 1140 in step 1035.

Once the AR data collection trigger DM command is received, the indoor IPTV device 1140 starts collecting audience research data. In step 1045, the indoor IPTV device 1140 monitors whether the reporting condition received at step 1020 is fulfilled. If the reporting condition is fulfilled, the indoor IPTV device 1140 sends an UPnP event to the home gateway 1130 in step 1050. At this time, the UPnP event can be sent along with the collected audience research data.

If the UPnP event is received, the home gateway 1130 sends a Generic Alert message with the collected audience research data to the device management server 1113 in step 1060.

As described above, the audience research data collection method and apparatus in accordance with the embodiments of the present invention are capable of collecting and reporting the audience research data per content according to a reporting condition set by the service provider. Additionally, the audience research data collection method and apparatus in accordance with the embodiments of the present invention enable an end user device to collect and automatically report audience research data according to the reporting conditions set per content, thereby facilitating statistical analysis of customer viewing patterns and management of the audience research data in the form of database.

Although certain embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. An audience research data reporting method of a device, comprising:
receiving an audience research data collection management object for collecting audience research data from a device management server;
configuring a reporting condition of the audience research data collection management object based on parameters received from the device management server; and
collecting and reporting the audience research data to the device management server according to the reporting condition.

2. The audience research data reporting method of claim 1, wherein configuring the reporting condition comprises setting the reporting condition for each content class.

3. The audience research data reporting method of claim 1, wherein the reporting condition comprises at least one of an audience research data collection limit, an audience research data memory limit, an audience research data report cycle, an audience research data collection frequency, and an audience research data reporting event.

4. An audience research data collecting method of a device management server, comprising:
sending an audience research data collection management object to a device;
sending the device a reporting condition configuration command for configuring a reporting condition of the audience research data collection management object; and
receiving audience research data collected by the device according to the reporting condition.

5. The audience research data collecting method of claim 4, wherein the reporting condition is set for each class, each class indicating a predetermined content type.

6. The audience research data collecting method of claim 4, wherein the reporting condition comprises at least one of an audience research data collection limit, an audience research data memory limit, an audience research data report cycle, an audience research data collection frequency, and an audience research data reporting event.

7. An audience research data reporting system comprising:
a device for receiving an audience research data collection management object for collecting audience research data from a device management server, configuring a reporting condition of the audience research data collection management object based on parameters received from the device management server, and collecting and reporting the audience research data to the device management server according to the reporting condition.

8. The audience research data reporting system of claim 7, wherein the device sets the reporting condition for each content class.

9. The audience research data reporting system of claim 7, wherein the reporting condition comprises at least one of an audience research data collection limit, an audience research data memory limit, an audience research data report cycle, an audience research data collection frequency, and an audience research data reporting event.

10. An audience research data collecting system comprising:
a device management server for sending an audience research data collection management object to a device, sending the device a reporting condition configuration command for configuring a reporting condition of the audience research data collection management object, and receiving audience research data collected by the device according to the reporting condition.

11. The audience research data collecting system of claim 10, wherein the reporting condition is set for each class, each class indicating a predetermined content type.

12. The audience research data collecting system of claim 10, wherein the reporting condition comprises at least one of an audience research data collection limit, an audience research data memory limit, an audience research data report cycle, an audience research data collection frequency, and an audience research data reporting event.
